(19) United States
(12) Patent Application Publication
(10) Pub. No.: US 2012/0042147 A1
(43) Pub. Date: Feb. 16, 2012

(54) MEMORY ALLOCATION METHOD AND A METHOD FOR MANAGING DATA RELATED TO AN APPLICATION STORED IN A SECURITY MODULE ASSOCIATED WITH A TERMINAL, AN ASSOCIATED SECURITY MODULE AND AN ASSOCIATED TERMINAL

(75) Inventors: Guillaume Duc, St. Pryve St. Mesmin (FR); Philippe Raipin Parvedy, Saint Ouen des Alleux (FR); Olivier Rochecouste, Caen (FR)

(73) Assignee: France Telecom, Paris (FR)

(21) Appl. No.: 13/119,780

(22) PCT Filed: Sep. 21, 2009
(86) PCT No.: PCT/FR2009/051766

§ 371 Date: Jun. 6, 2011

(30) Foreign Application Priority Data
Sep. 22, 2008 (FR) 0856345

(51) Int. Cl. G06F 12/02

(52) U.S. Cl. 711/170; 711/E12.002

(57) ABSTRACT

A method is provided for allocating memory associated with an application of a security module of a terminal, including the steps of receiving from said application a request for allocation of memory external to the security module, of sending a memory allocation command to the terminal, and of receiving and storing memory allocation information in association with an identifier of said application. A method is also provided for managing data for such application, including the steps of receiving a request to read or write in an external memory, and of determining and sending a read or write command as a function of said request and the memory allocation information associated with the application identifier in order to read or write data. A security module and a terminal including that security module are also provided.

The invention relates to the field of mobile telecommunications and more particularly to that of managing applications of a mobile terminal.

At present, a user of a mobile terminal of the mobile telephone type is faced with an increasingly rich offer of services. In addition to standard telephone services, the user is offered a gamut of diverse and varied services such as payment services, transport services, etc. These services are accessible either locally, or via a mobile telephone network (GSM, GPRS, etc.), or via near-field communication, for example employing dialog protocols such as Bluetooth, RFID, etc.

These services rely on applications that are stored either directly in the mobile terminal or in a security module, for example a microchip card, inserted therein. These applications include a data area in addition to a program part. Storing data in the security module is very secure because the security module controls access to the data.

With the increasing number of applications to be stored and the need for some applications to have access to a large data area, a problem of available memory space is making itself felt.

The solution of inserting more memory into the security module increases the cost of the security module. Given the number of mobile telephones, this cost may become prohibitive for mobile telephone carriers if they have to cover it.

Document U.S. Pat. No. 7,263,383 discloses a method of increasing the memory size of an address book stored in a SIM card of a mobile terminal equipped with a flash memory card in which part of the information is stored in the SIM card and complementary information is stored in the flash memory in association with an identification number of the SIM card. The mobile terminal retrieves the data stored in the SIM card after reading the identification number in the SIM card. That method does not work if the application is installed in the SIM card because the SIM card has no means of controlling resources other than its own resources.

The present invention aims to improve on this situation.

To this end, the present invention proposes a method of allocating memory associated with an application stored in a security module associated with a terminal, the method being characterized in that it includes:
a step of receiving from said application a request for allocation of memory external to the security module;
a step of sending the terminal a memory allocation command as a function of said request;
a step of receiving memory allocation information determined from the allocation command; and
a step of storing the received memory allocation information in association with an identifier of said application.

Thus according to the invention a security module such as a SIM card of a mobile terminal having a small memory is able to reserve one or more memory areas accessible to the terminal. The reserved memory area may be in a flash memory of the terminal, an internal memory area of the terminal, a memory area on a remote server accessible by the terminal via a telecommunications network or any other memory area accessible by the terminal.

In one particular implementation, the allocation command includes at least one access characteristic and the memory allocation information is determined as a function of said at least one characteristic.

One example of an access characteristic is information relating to the latency (or access time) of the memory. If the application or the security module demands as short as possible an access time, the terminal chooses if possible a memory area internal to the terminal rather than a memory area on a remote server.

Another example of an access characteristic is information relating to the volatility of the memory. Thus the terminal may select a volatile memory area, for example in RAM, for storing temporary application data or, on the contrary, a memory area in EEPROM if the data must be kept.

In one particular implementation, the allocation method further includes a step of determining at least one security parameter and a step of storing said at least one security parameter in association with the application identifier.

One example of such a security parameter is an encryption key for guaranteeing the confidentiality of the data during transfer thereof and storage thereof outside the security module.

Another example of a security parameter is a key for signing the data to control its integrity.

The security module generates and stores the security parameter or parameters. The fact that these keys are known only to the security module strengthens the security of the system and guarantees a data security level identical to that which would be obtained if the data were stored in a memory internal to the security module.

The invention also provides a method of managing data associated with an application stored in a security module associated with a terminal, the method being characterized in that, with memory allocation information being stored in association with an identifier of said application, the method includes the following steps:
receiving a request to read or write in an external memory, said request containing the application identifier;
determining a read or write command as a function of said request and the memory allocation information associated with the application identifier; and
sending said read or write command in order to read or write data in the external memory.

Thus an application that has reserved a memory area external to the security module may access that memory to store and then to read application data. It thus has available an additional memory area.

According to one particular feature, at least one security parameter being stored in association with the application identifier, the step of determining a write command includes a step of applying said at least one security parameter to the data to write.

One or more security parameters, for example secret keys, generated and stored during the preliminary allocation phase are then used to guarantee the security of the data stored externally of the security module.

According to one particular feature, at least one security parameter being stored in association with the application identifier, and the request being a read request, the method further includes a step of applying said at least one security parameter to the read data.

Thus applying one or more security parameters to the data read in an external memory before any use thereof by the application guarantees the security of the data.

For example, if a security parameter in the form of a secret encryption key is stored during the preliminary allocation phase, that key may then be used to encrypt the data before it is sent from the security module to the allocated memory. The security module also uses this key to decrypt encrypted data read in the external memory. Storing the data in encrypted form guarantees the confidentiality of the data.

The invention further provides a terminal including means for receiving a memory allocation command from the security module, means for allocating a memory area as a function of the received allocation command, means for determining memory allocation information relating to said allocated area, means for sending said memory allocation information, means for receiving a command to read or write in said allocated memory area, means for accessing said allocated area, and means for sending data read in said allocated area.

In one particular embodiment, the allocation means are able to determine a memory area as a function of at least one access characteristic contained in the received allocation command.

Thus if the terminal has a plurality of types of memory available, it may select the most suitable memory as a function of one or more criteria provided by the security module and/or by the application.

In one particular variant of this embodiment, the at least one access characteristic relates to the speed of access to the memory.

The invention further provides a security module including means for receiving from said application a request for allocation of external memory, means for sending a memory allocation command as a function of said request, means for receiving memory allocation information determined from the allocation command, means for storing the received memory allocation information in association with an identifier of said application, means for receiving a request to read or write in an external memory, said request containing the application identifier, means for determining a read or write command as a function of said request and the memory allocation information associated with the application identifier, and means for sending said read or write command in order to read or write data in the external memory.

The invention further provides a system including a terminal and a security module as described above.

The invention finally provides a computer program product comprising instructions for executing steps of the allocation method and/or the management method as described above when it is loaded into and executed by a processor.

Other particular features and advantages of the present invention become apparent in the course of the following description of embodiments given by way of non-limiting example and with reference to the appended drawings, in which:

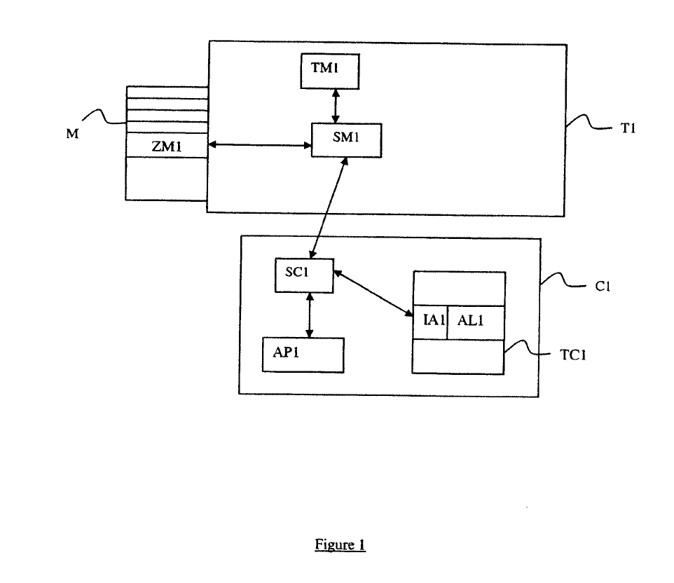

FIG. 1 is a diagram showing a system of a first embodiment of the invention;

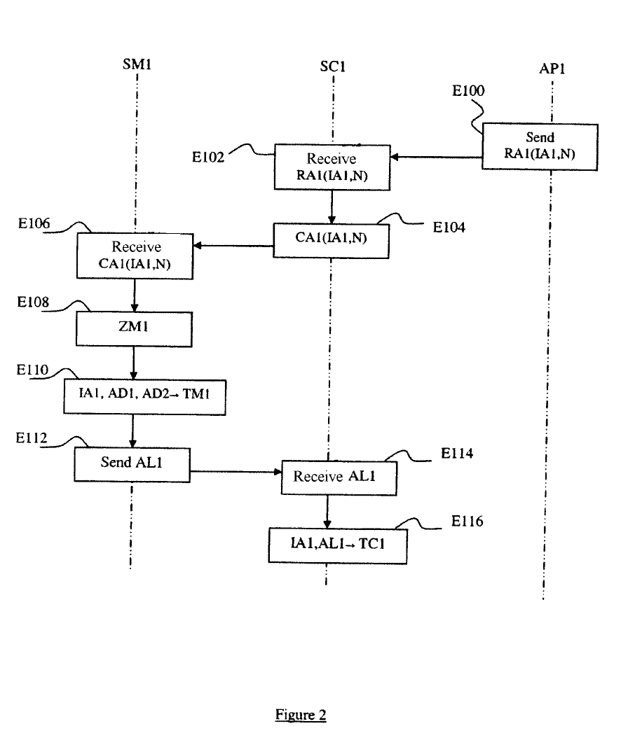

FIG. 2 is a flowchart showing the different steps of an allocation method of a first implementation of the invention;

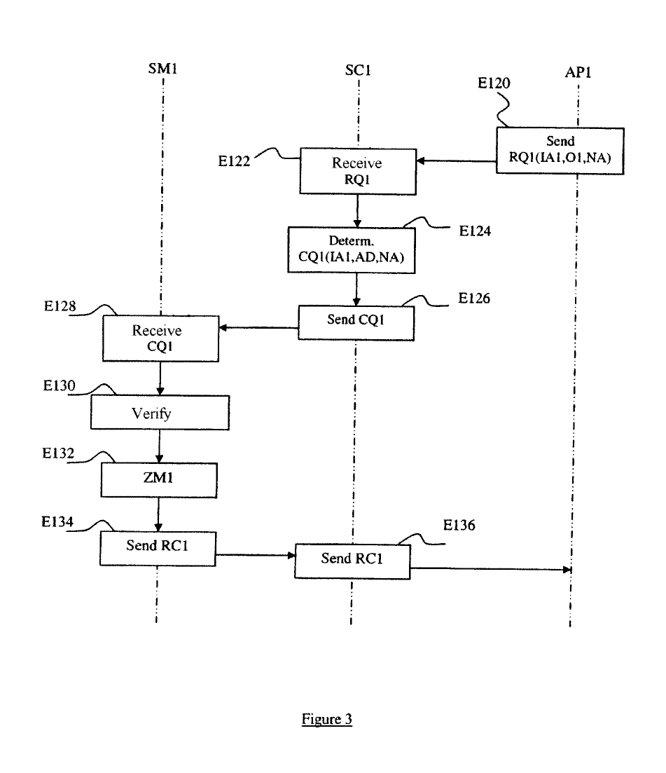

FIG. 3 is a flowchart showing the different steps of a management method following execution of an allocation method of a first implementation of the invention;

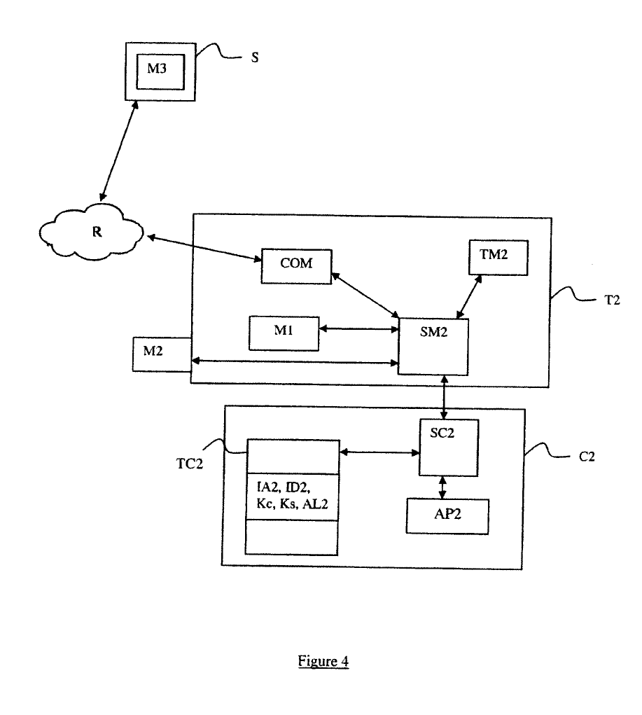

FIG. 4 is a diagram showing a system of a second embodiment of the invention;

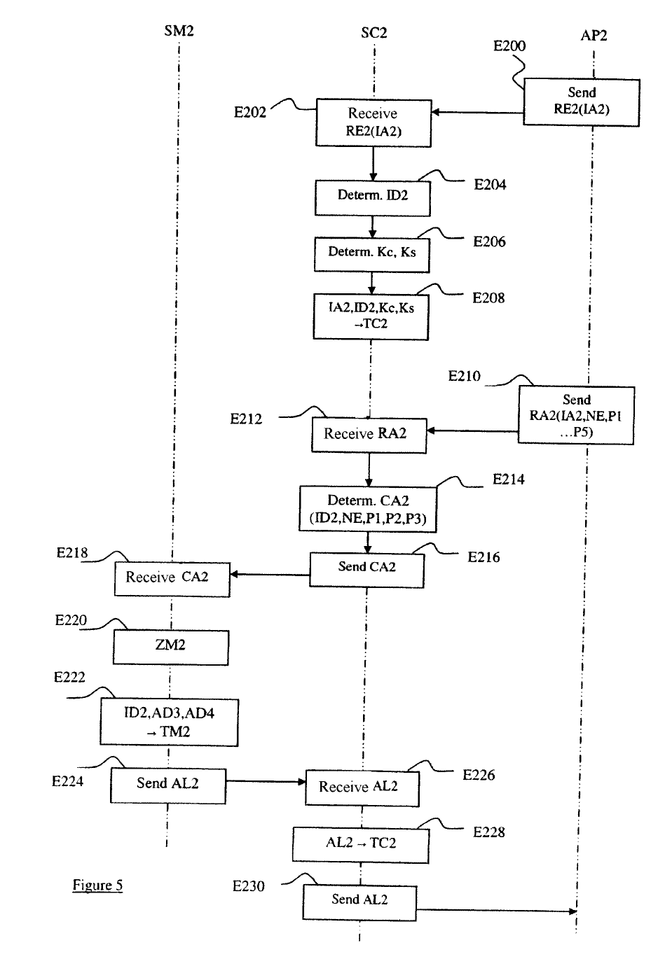

FIG. 5 is a flowchart showing the different steps of an allocation method of a second implementation of the invention;

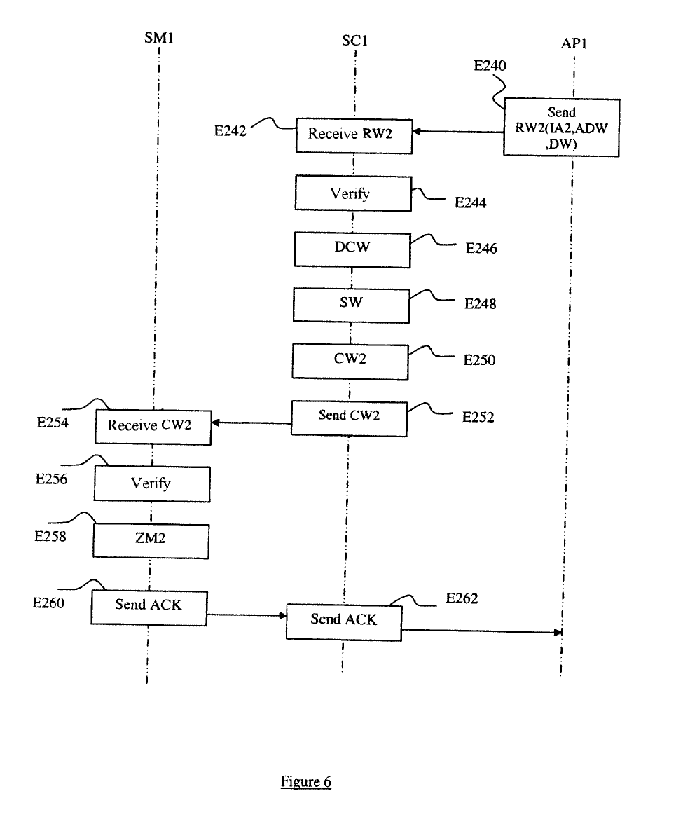

FIG. 6 is a flowchart showing the different steps executed to write data following execution of an allocation method of a second implementation of the invention;

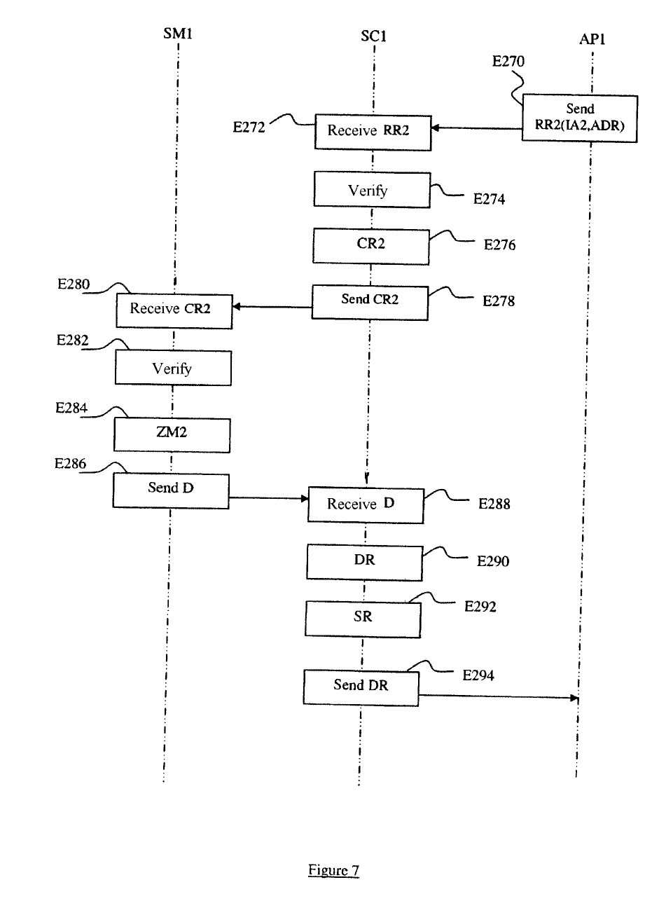

FIG. 7 is a flowchart showing the different steps executed to read data following execution of an allocation method of a second implementation of the invention; and

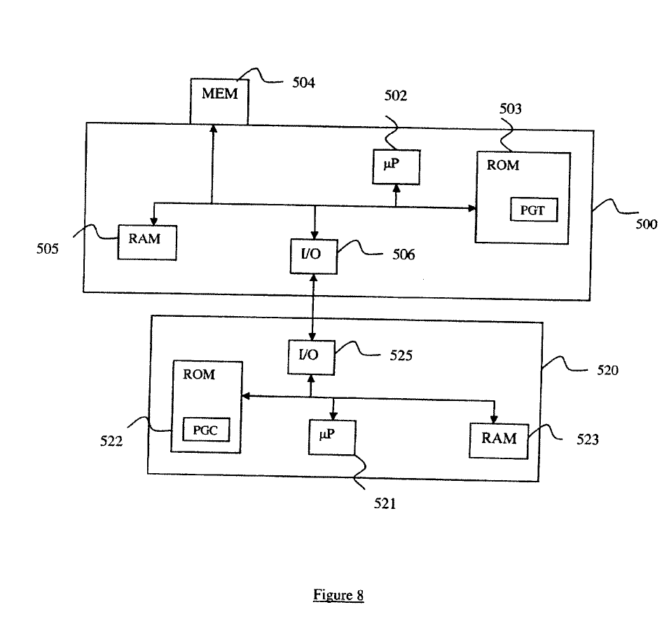

FIG. 8 is a block diagram showing a system able to execute the steps of an allocation method and/or a management method of one embodiment of the invention.

A method of a first implementation of the invention of allocating memory for an application and a data management method of the invention are described below with reference to FIGS. 1 to 3.

Referring to FIG. 1, a user has a terminal T1, for example a mobile telephone or a PDA (Personal Digital Assistant).

Alternatively, the terminal T1 is a personal computer (PC).

The terminal T1 includes memory M and a module SM1 for managing that memory.

The memory M is for example an external flash memory inserted into a port of the terminal.

Alternatively, the memory M is a memory area of the terminal.

The management module SM1 is able to access the memory M to write or read data.

The terminal T1 also includes a security module C1.

The security module C1 is for example a removable medium of SIM type or UICC (Universal Integrated Circuit Card) type or a memory card hosting a secure element (SD card, embedded secure controller, etc.).

The security module C1 contains an application AP1.

The application AP1 is a protected application, for example, i.e. an application having at least some data that must not be modifiable by a user.

The application AP1 is for example an application requiring the storage of a large volume of data. For example, the application AP1 is a transport application, and data storage is executed each time a user enters the transport system.

The security module C1 also includes a control module SC1. This control module SC1 is able to communicate with the management module SM1 of the terminal T1.

One implementation of the allocation method is described below with reference to FIG. 2.

During a first step E100, the application AP1 sends the control module SC1 an allocation request RA1. This allocation request includes in particular an identifier IA1 of the application, for example its AID (Application IDentifier) and a value N representing the requested size of the external memory. This value N is a plurality of bytes, for example.

The request RA1 is received by the control module SC1 during a step E102 after which, during a step E104, the control module SC1 sends the management module SM1 of the terminal T1 an allocation command CA1. In this implementation, the allocation command CA1 is the received request RA1.

The management module SM1 of the terminal T1 receives the allocation command CA1 during a step E106. During a subsequent step E108, the management module SM1 determines a memory area ZM1 in the memory M. This memory area ZM1 is an unused area of the memory M satisfying the size criterion contained in the allocation command CA1.

During the next step E110, the management module SM1 stores in a management table TM1 of the terminal T1 the start address AD1 of the determined area ZM1 and the end address AD2 of the determined area ZM1 in association with the identifier IA1 of the application AP1. The start address AD1 and the end address AD2 of the area ZM1 constitute memory allocation information AL1.

During a step E112, the memory allocation information AL1 is sent to the control module SC1. Following reception of this information (step E114), in a step E116, the control module SC1 stores this memory allocation information AL1 in a correspondence table TC1 of the security module C1 in association with an application identifier IA1.

One implementation of the management method is described below with reference to FIG. 3.

This management method is used following allocation of a memory area ZM1 external to the security module C1 and associated with the application AP1, for example using an allocation method as described above.

During a step E120, the application AP1 sends the control module SC1 of the security module C1 a read or write request RQ1. This request RQ1 includes the access type (read or write), the identifier IA1 of the application AP1, and information relating to the area to read or to write. For example, this information relating to the area to read or write consists firstly of a value corresponding to an offset O1 relative to the beginning of the reserved area ZM1 and secondly of the number NA of bytes to read or write. If the request RQ1 is a write request, it also contains the data to write.

The control module SC1 receives this request RQ1 during a step E122. Then, during a step E124, the control module SC1 determines a read or write command CQ1 corresponding to the received request RQ1. In this implementation, the read or write command CQ1 contains the access type (read or write) contained in the request RQ1, the identifier IA1, an address AD, and the number NA of bytes to write or read. If the request is a write request, the command CQ1 also contains the data to write.

The address AD is determined by the control module SC1 from firstly the memory allocation information AL1 stored in the correspondence table TC1 in association with the identifier IA1 and secondly the offset O1 received in the request RQ1.

During a subsequent step E126, the command CQ1 is sent to the management module SM1 of the terminal T1, which receives it during a step E128.

The step E128 is followed by a step E130 during which the management module SM1 verifies in the management table TM1 whether the requested area is reserved for the application AP1. Then, if this is so, it commands writing or reading of the data in the area ZM1 (step E132).

The step E132 is followed by a step E134 during which the management module SM1 sends the control module SC1 a response RC1. This response contains the read data if the command CQ1 is a read command. It contains information relating to the execution of the command if the command CQ1 is a write command.

The control module SC1 then sends the response RC1 to the application AP1 (step E136).

A second implementation of a method of allocating an application memory and of a method of managing data of the invention are described below with reference to FIGS. 4 to 7.

Referring to FIG. 4, a user has a terminal T2, for example a mobile telephone or a PDA (Personal Digital Assistant).

The terminal T2 includes a first memory M1 that is a memory area internal to the terminal T2 and a second memory M2 that is a removable external memory, such as a flash memory, inserted into the terminal.

The terminal T2 also includes a communications module COM enabling the terminal to access a memory area M3 of a remote server S via a telecommunications network R.

The terminal T2 also includes a management module SM2 for managing the memories M1, M2, and M3. The purpose of the management module SM2 is explained below.

The terminal T2 also includes a security module C2.

The security module C2 is for example a removable medium of SIM or UICC (Universal Integrated Circuit Card) type or a memory card hosting a secure element (SD card, embedded secure controller, etc.).

The security module C2 contains an application AP2. Alternatively, it contains a plurality of applications. The application AP2 is a payment application, for example.

The security module C2 further contains a control module SC2. This control module SC2, responsible for security and the purpose of which is described below, is able to communicate with the management module SM2 of the terminal T2.

Because the control module SC2 of the security module C2 is not able to initiate communications with the management module SM2 of the terminal T2, the management module SM2 regularly sends a command to the control module SC2. If the control module SC2 has a request to be sent to the management module SM2, it includes that request in a response message to this command.

One implementation of the allocation method in which the application AP2 reserves an external memory area is described below with reference to FIG. 5.

During a first step E200, the application AP2 is registered with the control module SC2. To this end, it sends the control module SC2 a registration request RE2 containing an application identifier IA2, for example its AID (Application IDentifier). After reception of this request, during a step E202, the control module SC2 checks that this application is not already registered and, during a step E204, generates a control identifier ID2 for this application AP2.

In one particular implementation, the control identifier ID2 is the application identifier IA2 sent by the application AP2.

During a step E206, the control module determines an encryption key kc and a signature key ks for the application AP2. As described in detail below, the encryption key kc is used to encrypt and decrypt data of the application AP2 to ensure the confidentiality of this data. The signature key ks is used to sign data of the application AP2 to ensure the integrity of this data. The keys ks and kc are generated at random. The keys kc and ks are security parameters.

Alternatively, only the key kc is determined.

During a step E208, the control module SC2 stores in a correspondence table TC2 of the security module C2 the control identifier ID2 and the keys kc and ks in association with the identifier IA2 of the application AP2.

Then, during a step E210, the application AP2 sends the control module SC2 a memory allocation request RA2. This allocation request RA2 contains in particular the identifier IA2 of the application AP2 and a number NE of records. Here a record represents a predetermined number of bytes, for example 128 bytes. The number NE determines the size of the memory to be reserved.

The request RA2 also contains one or more access characteristics enabling the application AP2 to specify the type of memory to allocate. In the implementation described here, three access characteristics are used. For example, an access characteristic P1 indicates if the memory to allocate must be a memory area reserved for the application AP2 or a memory area shared between a plurality of applications. A second access characteristic P2 is latency information and indicates if the memory area must be accessed quickly or not. A third characteristic P3 indicates if the data must be stored on a non-volatile or a volatile medium, a volatile memory being suitable for storing temporary data.

The request RA2 also contains two security characteristics P4 and P5 relating to the security of the data. One security characteristic P4 indicates if the data is required to be confidential. The security characteristic P5 specifies the type of integrity that is required for the data. For example, P5 may specify that a simple integrity check is required or that an anti-playback mechanism must be used.

In the implementation described here, all of the characteristics P1 to P5 used are coded on one byte.

Alternatively, the number and type of the access characteristics and of the security characteristics used are different.

The control module SC2 receives the request RA2 during a step E212 after which, during a step E214, the control module SC2 determines an allocation command CA2 as a function of the received request RA2. This allocation command CA2 contains the control identifier ID2 determined during the step E204, the access characteristics P1, P2, and P3, and the number NE of records requested.

In the implementation described here, the access and/or security characteristics are sent by the application AP2. This configuration enables management to be adapted to suit each application.

Alternatively, some or all of the access and/or security characteristics are determined by the control module SC2 of the security module C2.

The allocation determined command CA2 is then sent to the management module SM2 of the terminal T2 during a step E216.

The management module SM2 of the terminal T2 receives the allocation command CA2 during a step E218. During a subsequent step E220, the management module SM2 determines a memory area ZM2 as a function of the access characteristics P1 to P3 and the number NE of records requested.

The area ZM2 is an area of the memory M1, of the memory M2 or of the memory M3.

For example, if the latency characteristic P2 is set at the value 0, the memory access time must be as short as possible. In this situation, the memory M1 is chosen in preference to the memory M3. In contrast, the remote memory M3 is chosen if there is insufficient space available in the memories M1 and M2.

During the subsequent step E222, the management module SM2 stores in a management table TM2 of the terminal T2 a start address AD3 of the area ZM2, which represents memory allocation information AL2, and an end address AD4 of the area ZM2, in association with the control identifier ID2 of the application AP2. The start address AD3 of the area ZM2 and the end address AD4 of the area ZM2 are physical addresses thereafter enabling the management module SM2 to access the memory area ZM2.

Alternatively, the management module SM2 stores in the management table TM2 the start address AD3 of the area ZM2 and the number NE of records reserved.

Another alternative is for the memory allocation information AL2 to consist of the area start address AD3 and the area end address AD4.

A further alternative is for the memory allocation information AL2 to be an identifier enabling the management module SM2 to retrieve the physical address of the area ZM2.

During a step E224, the memory allocation information AL2 is forwarded to the control module SC2 of the security module C2. Following reception of this information (step E226), during a step E228, the control module SC2 stores this memory allocation information AL2 in the correspondence table TC2 of the security module C2 in association with the application identifier IA2.

During a subsequent step E230, the control module SC2 sends the memory allocation information AL2 to the application AP2.

In the implementation described here, the application AP2 sends a storage request RE2 and an allocation request RA2.

Alternatively, the application sends only an allocation request and the steps of determining a control identifier, determining the security parameters, and storage in a correspondence table are effected by the control module on reception of this allocation request.

One implementation of a management method in which the application AP2 sends a write request is described below with reference to FIG. 6.

This management method is executed following the allocation of a memory area ZM2 associated with the application AP2 and external to the security module C2, for example using an allocation method as described above.

During a step E240, the application AP2 sends the control module SC2 a write request RW2. The write request RW2 contains the application identifier IA2 of the application AP2, an access type (read or write), the security characteristics (P4, P5), an address ADW relative to the area ZM2 allocated, and data DW to write. For example, the address ADW sent is the address of a record to write and is calculated by the application AP2 from the memory allocation information AL2, which here is the start address AD3 of the area ZM2 received in response to the allocation request RA2.

The control module SC2 receives the request RW2 during a step E242. During a subsequent step E244 the control module SC2 verifies whether the application AP2 is registered, looks up the application identifier IA2 in the correspondence table TC2, and verifies whether this application has been allocated a memory area.

If no external memory area has been allocated to the application AP2, the control module SC2 is not able to process the request received. It sends the application AP2 an error message.

Alternatively, it does not respond.

If a memory area has been allocated, the control module SC2 then verifies whether the address ADW contained in the request corresponds to the address of a record accessible by the application AP2 using the memory allocation information AL2 stored in the table TC2 in association with the application identifier IA2 of the application AP2.

If the security characteristic P4 contained in the write request RW2 is set to the value 1, for example, the data DW must be written in a confidential manner and during a step E246 the control module SC2 encrypts the data to write using the key kc read in the correspondence table TC2 in association with the application identifier IA2. It thus obtains the encrypted data DCW.

If the security characteristic P5 is set to the value 01, for example, the application AP2 requires a simple integrity check on the data and during a step E248 the control module SC2 calculates a signature SW for the data DW to write using the key ks stored in the correspondence table TC2 in association with the application identifier IA2.

Then, during a step E250, the module SC2 determines a write command CW2 as a function of the request RW2 received. To be more precise, the write command CW2 contains the command type (write), the control identifier ID2, the address ADW, the encrypted data DCW, and the signature SW.

During a subsequent step E252, the write command CW2 is sent to the management module SM2 of the terminal T2, which receives it during a step E254.

The step E254 is followed by a step E256 during which the management module SM2 verifies in the management table TM2 of the terminal T2 whether the area requested for writing is reserved for the application AP2. If this is so, it commands writing of the encrypted data DCW and the signature SW in the area ZM2 at the address ADW (step E258).

The step E258 is followed by a step E260 during which the management module SM2 sends the control module SC2 information ACK relating to execution of the command CW2.

The control module SC2 then forwards the information ACK to the application AP2 (step E262).

One implementation of a management method in which the application AP2 sends a read request is described below with reference to FIG. 7.

This management method is used following the allocation of a memory area ZM2 associated with the application AP2 and external to the security module C2, for example using an allocation method as described above.

During a step E270, the application AP2 sends the control module SC2 of the security module C2 a read request RR2. This read request RR2 contains the application identifier IA2 of the application AP2, the security characteristics (P4, P5), and the address ADR of a record from the external memory area ZM2 allocated to the application AP2. The application AP2 calculates the address ADR of the record from the area start address AD3 received in response to the allocation request RA2.

The control module SC2 receives the read request RR2 during a step E272. During a step E274, the control module SC2 verifies whether the address ADR contained in the request RR2 corresponds to the address of a record accessible to the application AP2 using the memory allocation information AL2 stored in the correspondence table TC2 of the security module C2 for the application AP2.

If the address ADR does not correspond to the address of a record accessible to the application AP2, the control module SC2 does not execute the received read request RR2.

Otherwise, during a step E276, the control module SC2 determines a read command CR2 as a function of the read request RR2. To be more precise, the read command CR2 contains the command type (read), the control identifier ID2 read in the correspondence table TC2, and the address ADR of the record to read.

During a subsequent step E278, the read request CR2 is sent to the management module SM2 of the terminal T2, which receives it during a step E280.

The step E280 is followed by a step E282 during which the management module SM2 verifies in the management table TM2 whether the address ADR received is an address from the area ZM2 allocated to the application AP2. If this is so, the management module SM2 commands reading in the area ZM2 and obtains the data D (step E284).

The step E284 is followed by a step E286 during which the management module SM2 sends the control module SC2 the data D.

The control module SC2 receives the data D during a step E288.

If the security characteristic P5 is set, the data D includes data DCR and a signature SW.

If the security characteristic P4 contained in the read request RR2 is set to the value 1, for example, confidentiality is required and the data DCR is encrypted. During a step E290, the control module SC2 decrypts the received data DCR using the key kc read in the correspondence table TC2 in association with the control identifier ID2. It thus obtains the decrypted data DR.

If the security characteristic P5 is set to the value 01, for example, the application AP2 requires a simple integrity verification of the data and during a step E292 the control module SC2 calculates a signature SR of the decrypted data DR using the key ks stored in the correspondence table TC2 in association with the control identifier ID2 and verifies whether the calculated signature SR corresponds to the signature SW received with the data. This verifies the integrity of the received data.

During a step E294, the control module SC2 sends the application AP2 a response message containing the decrypted data DR.

In the implementation described here, the application AP2 is an application stored in the security module SC2.

The invention may equally be applied to an application stored in the terminal T2. The allocation method then includes, in addition to the steps described above, a step during which the control module SC2 generates a key kv, stores the generated key kv in the correspondence table TC2 in association with the control identifier ID2, and sends this key kv to the application. All exchanges between the application and the control module are then signed using this key kv, thus enabling both the application and the security module to verify the integrity of the exchanged data.

In an embodiment shown in FIG. 8, a system using an allocation method and/or a management method of the invention comprises a mobile terminal 500 and a security module 520, for example.

As in the prior art, the mobile terminal 500 includes a processor unit 502 equipped with a microcompressor, a read-only memory (ROM or EEPROM) 503, an additional EEPROM 504, a random-access memory (RAM) 505, and a send-receive module 506 for communicating with the security module 520 inserted into the terminal.

The terminal 500 may include in the conventional way the following elements (this list is not exhaustive): an interface for communicating with a communications network, a keyboard, a screen, a microphone, a loudspeaker, a disk drive, storage means, etc.

The read-only memory 503 of the terminal 500 contains registers storing a computer program PGT including program instructions adapted to receive a memory allocation command from a security module, to allocate a memory area as a function of the received allocation command, to determine memory allocation information relating to said allocated area, to send said memory allocation information, to receive a command to read or write in said allocated memory area, to access said allocated area, and to send data read in said allocated area.

On powering up, the program PGT stored in the read-only memory 503 is transferred into the random-access memory of the terminal that then contains executable code and registers for storing the variables necessary for implementing the invention.

More generally, storage means readable by a computer or by a microprocessor, possibly integrated into the device, and possibly removable, store a program implementing the invention.

The secure module 520 is a subscriber card for example that, as in the prior art, includes a processor unit 521 equipped with a microprocessor, a read-only memory (ROM) 522, a random-access memory (RAM) 523, and a send-receive module 525 for communicating with the mobile terminal 500.

The read-only memory 522 of the security module 520 contains registers storing one or more computer programs including program instructions adapted to execute one or more applications (AP1, AP2, etc.). It also includes registers storing a computer program PGC including program instructions adapted to implement an allocation and/or management method of the invention as described with reference to FIGS. 1 to 7. This program is therefore adapted to receive from an application a request for allocation of external memory, to send a memory allocation command as a function of said request, to receive memory allocation information determined from the allocation command, to store the received memory allocation information in association with an identifier of said application, to receive a request to read or write in an external memory, said request including the application identifier, to determine a read or write command as a function of said request and the memory allocation information associated with the application identifier, and to send said read or write command in order to read or write data in the external memory.

On powering up, the program PGC stored in the read-only memory 522 of the security module 520 is transferred into the random-access memory of the security module that then contains executable code and registers for storing variables necessary for implementing the invention.

More generally, storage means, readable by a computer or by a microprocessor, possibly integrated into the device, and possibly removable, store a program implementing the invention.

1. A method of allocating memory associated with an application stored in a security module associated with a terminal, the method comprising steps of:
receiving from said application a request for allocation of memory external to the security module;
sending the terminal a memory allocation command as a function of said request;
receiving memory allocation information determined from the allocation command; and
storing the received memory allocation information in association with an identifier of said application.

2. The allocation method according to claim 1, wherein the allocation command comprises at least one access characteristic and the memory allocation information is determined as a function of said at least one characteristic.

3. The allocation method according to claim 1, further comprising a step of determining at least one security parameter and a step of storing said at least one security parameter in association with the application identifier.

4. A method of managing data associated with an application stored in a security module associated with a terminal, the method comprising the following steps:
storing memory allocation information in association with an identifier of said application;
receiving a request to read or write in an external memory, said request containing the application identifier;
determining a read or write command as a function of said request and the memory allocation information associated with the application identifier; and
sending said read or write command in order to read or write data in the external memory.

5. The management method according to claim 4, wherein, at least one security parameter is stored in association with the application identifier, the step of determining a write command comprises a step of applying said at least one security parameter to the data to write.

6. The management method according to claim 4, wherein at least one security parameter is stored in association with the application identifier, and the request being a read request, the method further comprises a step of applying said at least one security parameter to the read data.

7. A terminal, comprising:
a receiver for receiving a memory allocation command from a security module;
an allocator for allocating a memory area as a function of the received allocation command;
a routine for determining memory allocation information relating to the allocated area;
a sender for sending said memory allocation information;
a receiver for receiving a command to read or write in said allocated memory area;
a routine for accessing said allocated area; and
a sender for sending data read in said allocated area.

8. A terminal according to claim 7, wherein the allocator is able to determine a memory area as a function of at least one access characteristic contained in the received allocation command.

9. The terminal according to claim 8, wherein the at least one access characteristic relates to a speed of access to the memory area.

10. A security module comprising:
a receiver for receiving from said application a request for allocation of external memory;
a sender for sending a memory allocation command as a function of said request;
a receiver for receiving memory allocation information determined from the allocation command;
a store for storing the received memory allocation information in association with an identifier of said application;
a receiver for receiving a request to read or write in an external memory, said request containing the application identifier;
a routine for determining a read or write command as a function of said request and the memory allocation information associated with the application identifier; and
a sender for sending said read or write command in order to read or write data in the external memory.

11. A system, comprising the terminal according to claim 7 and the security module comprising:
a receiver for receiving from said application a request for allocation of external memory;
a sender for sending a memory allocation command as a function of said request;
a receiver for receiving memory allocation information determined from the allocation command;
a store for storing the received memory allocation information in association with an identifier of said application;
a receiver for receiving a request to read or write in an external memory, said request containing the application identifier;
a routine for determining a read or write command as a function of said request and the memory allocation information associated with the application identifier; and
a sender for sending said read or write command in order to read or write data in the external memory.

12. A non-transitory computer program product comprising instructions for executing steps of at least one of the allocation method according to claim 1 and the management method, comprising the following steps:
storing memory allocation information in association with an identifier of said application;
receiving a request to read or write in an external memory, said request containing the application identifier;
determining a read or write command as a function of said request and the memory allocation information associated with the application identifier; and
sending said read or write command in order to read or write data in the external memory,
when it is loaded into and executed by a processor.
